(19) United States
(12) Patent Application Publication
(10) Pub. No.: US 2006/0070251 A1
(43) Pub. Date: Apr. 6, 2006

(54) Line-marking device with rotatable laser

(76) Inventor: Shuming Wu, Nanjing City (CN)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/288,010

(22) Filed: Nov. 28, 2005

Related U.S. Application Data
(63) Continuation-in-part of application No. 10/706,227, filed on Nov. 12, 2003.

(30) Foreign Application Priority Data
Dec. 1, 2004 (CN) 200420109300.5

(51) Int. Cl. G01C 15/00

(52) U.S. Cl. 33/286

(57) ABSTRACT

A line-marking device with rotatable laser disclosed in the present invention comprises a laser rotating and locating system including a fixing member and a rotating member, one of which has a gear-shaped component, and the other member of which has a component that can be engaged with the gear-shaped component, and an elastic member pressing the engaged component to the gear-shaped component. The laser-emitting device is fixedly connected to the rotating member. A straight line formed by the laser on a wall can be rotated along with the rotating member. In an effect of the elastic member and by the interaction between the gear-shaped component and the engaging component for it, a location can be obtained when the two component is rotated across a space of a tooth, so that a fan-shaped beam emitted from the laser line-marking device can not only be rotated from the 0 degree to the 360 degrees, but also be reliably located at a plurality of angles.

### CROSS-REFERENCE TO RELATED APPLICATIONS

This application claims priority to Chinese Patent Application No. 200420109300.5, filed on Dec. 1, 2004; and is a continuation-in-part of U.S. patent application Ser. No. 10/706,227 filed on Nov. 12, 2003 and published on Oct. 21, 2004 as Publication No. 2004-0205972 A2, which claims priority to Chinese Patent Application No. 02293048.5 filed Dec. 27, 2002. Priority to these applications is claimed under 35 U.S.C. §§ 119 and 120, and the disclosure of these applications is incorporated herein by reference in their entirety.

### FEDERALLY SPONSORED RESEARCH OR DEVELOPMENT

Not applicable.

### TECHNICAL FIELD

The present invention relates to a laser line-marking device, which can project a fan-shaped laser beam onto a wall or surfaces of other objects to be aligned to form a straight line thereon as a reference line with the aid of which the user can carry on other operations.

### BACKGROUND OF THE INVENTION

With the technical development, the laser beam is used more and more in various fields. Especially in the recent years, a laser line-marking device has been more popularly used independently or in combination with all kinds of electric tools and civilian apparatus. A rotatable function of the laser beam has been realized by some manufactories, so as to improve its actual utility.

However, the laser rotating devices at the present time generally can't locate the laser at multi-degrees, but merely locate the laser on several positions at some predetermined degrees, such as horizontal or vertical positions. Some present laser line-marking devices can be rotated to different degrees, but because there's no reliable location device thereon the laser of it can be easily departed from the desired positions because of some factors such as vibration with the result of inaccurate locations of the laser. Some others can only rotate from 0 to 90 degrees. High accuracy is always required for the laser line-marking device because it is often used for aligning or indicating a horizontal line or a vertical line. However, the laser line-marking devices in the current art cannot fulfill the various requirements now.

The present invention is provided to solve the problems discussed above and other problems, and to provide advantages and aspects not provided by prior laser line-marking devices of this type. A full discussion of the features and advantages of the present invention is deferred to the following detailed description, which proceeds with reference to the accompanying drawings.

### SUMMARY OF THE INVENTION

One object of the present invention is to provide a laser line-marking device that provides for multi-degrees of rotation and location of a fan-shaped laser line.

In order to achieve the above-mentioned object, a laser line-marking device according to the present invention comprises a laser rotating and locating system. The laser rotating and locating system includes a fixing member and a rotating member, one of which comprises a gear-shaped component, and the other of which comprises an engaging device for engaging with the gear-shaped component. The laser rotating-locating system also includes an elastic device for urging the engaging device into engagement with the gear-shaped component.

By the interaction between the gear-shaped component and the engaging device for it, and also by the effect of the elastic device, a fan-shaped beam emitted from the laser line-marking device can be rotated from 0 to 360 degrees, and also reliably located or held at any number of degrees therebetween.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a laser line-marking device according to a first preferred embodiment of the present invention;

FIG. 2 is a schematic side view of the laser rotating-locating system in FIG. 1;

FIG. 3 is an alternative schematic view of the laser rotating-locating system in FIG. 2;

FIG. 4 is a partial enlarged view of FIG. 3, showing an engagement state between a steel ball and teeth of the gear-shaped component;

FIG. 5 is a schematic view showing the position relationship between the steel ball and the teeth which are rotated a certain degree from the position thereof in FIG. 4;

FIG. 6 is a cut-away schematic view of a laser rotating and locating system according to a second preferred embodiment of the present invention;

FIG. 7 is a cut-away schematic view of a laser rotating and locating system according to a third preferred embodiment of the present invention;

FIG. 8 is a schematic view of a laser rotating and locating system according to a fourth preferred embodiment of the present invention;

FIG. 9 is a schematic view of a structure of the tooth flank of the rotating member in FIG. 8;

FIG. 10 is a schematic view showing that a laser line emitted from a laser line-marking device according to the present invention can be rotated on a wall.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

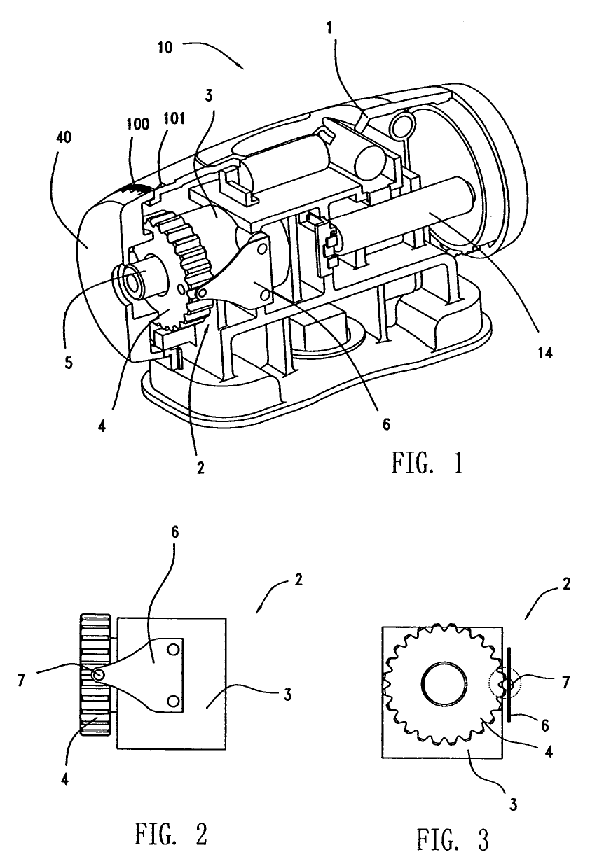

As shown in FIG. 1, the line-marking device 10 with rotatable laser line according to the present invention mainly comprises a housing 1, a power supply system 14, a laser-emitting device 5 and a laser rotating and locating system 2. The laser rotating and locating system 2 includes a fixing member 3, a rotating member 4 and a spring plate 6. The laser-emitting device 5 is fixed to the rotating member 4 so that the laser-emitting device 5 can be rotated along with the rotating movement of the rotating member 4 with the result that rotating movement of the fan-shaped laser beam can be achieved from 0 to 360 degrees or any angle in between. In practice, the rotating member 4 itself can be a laser-emitting member including a prism (or lens) and a laser diode (not shown). In another embodiment, it can be that only the prism (or lens) can be rotated along with the rotating member 4 while the laser diode is fixed and immoveable, thereby the rotating movement of the laser beam can also be achieved. And the variations and modifications in this way are obvious for the persons ordinarily skilled in the art to understand

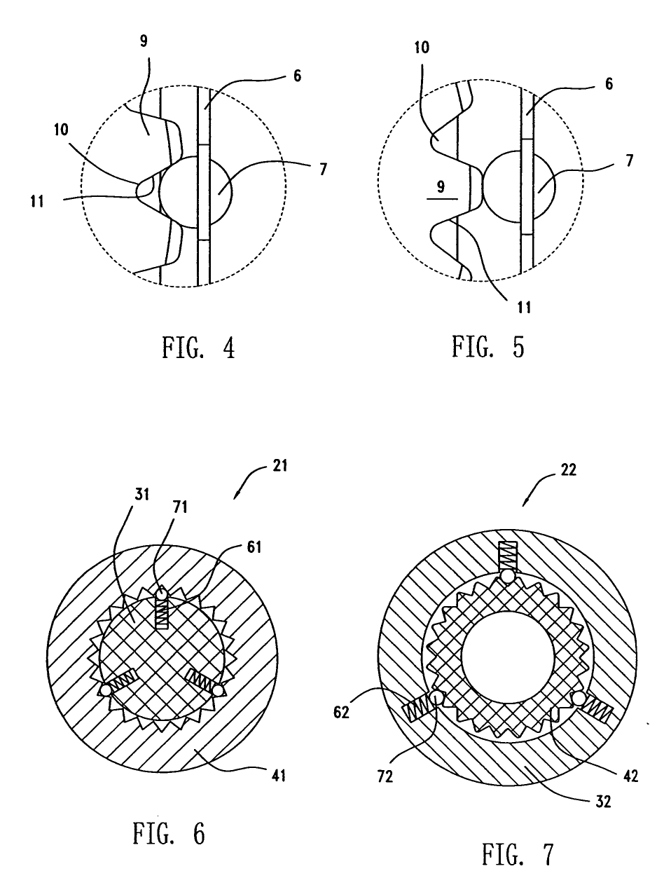

As shown in FIGS. 2-5, one end of the spring plate 6 is fixed on the fixing member 3, on the other end of which a steel ball 7 is mounted. A plurality of teeth 9 are formed on the outer edge of the rotating member 4. And the steel ball 7 is pressed in one of slots 10 between the teeth of the rotating member 4 by the elastic action of the spring plate 6. Side walls 11 of the slots 10 are preferred inclined planes as shown in FIG. 3, so that the side wall 11 is actuated to bring a pushing force in radial direction to bear on the steel ball 7 to make the steel ball 7 overcome the resistance from the spring plate 6 to rise along the side wall 11 to the top of the tooth-shaped key 9 as shown in FIG. 5 when the rotating member 4 is rotated by external torsion. When the rotating member 4 is continuously rotated, the steel ball is actuated to slide along the side wall 11 into another slot 10 between the teeth. It is obvious that a securing position is determined as a result of the engagement between the steel ball 7 and the slot 10 in the effect of the pressure of the spring plate 6 when the steel ball 7 is located in the slot 10, and the rotating member 4 cannot be rotated until the rotating member 4 is supplied a torsion force larger enough to overcome the above-mentioned force. In this way a reliable location can be realized at a plurality of angles in the range of 0 to 360 degrees, and more accurately held at any such desired angle. In the embodiment in practice, more accurate location at more degrees can be achieved by increasing the number of the teeth.

The steel ball 7 in the above-mentioned embodiment can also be a sphericity member, or a cylindrical member the longitudinal axis of which runs along the extending direction of the slots, or even a protrusion in other shapes. In addition, alternatively, the spring plate can also be fixed on the rotating member and the teeth are provided on the circumference of the fixing member, whereby the above-mentioned accurate and multi-degrees location in 360-degrees can also be achieved.

FIG. 6 is a cut-away schematic view of a laser rotating and locating system 21 according to a second preferred embodiment of the present invention. At least a portion of a fixing member 31 is provided inside the cavity of a rotating member 41. And three springs 61 are installed in the fixing member 31 along its radial direction. One steel ball 71 is provided between each top of the springs 61 and the side wall of the teeth of the rotating member 41. The three sets of the springs 61 and the steel balls 71 in the present embodiment can be exchanged by one set, two sets, or more than three sets based on the actual requirements. In the same way as in the first embodiment, when the rotating member 41 is rotated, the steel balls 41 and the springs 61 can act on the teeth so that the location and hold function can be achieved.

FIG. 7 is a cut-away schematic view of a laser rotating and locating system 22 according to a third preferred embodiment of the present invention. It is similar to the second embodiment in function and structure except that a rotating member 42 is installed in a fixing member 32.

The springs in the above-mentioned second and third embodiments may also be installed on the rotating member, and the teeth can be provided on the outer edge of the fixing member.

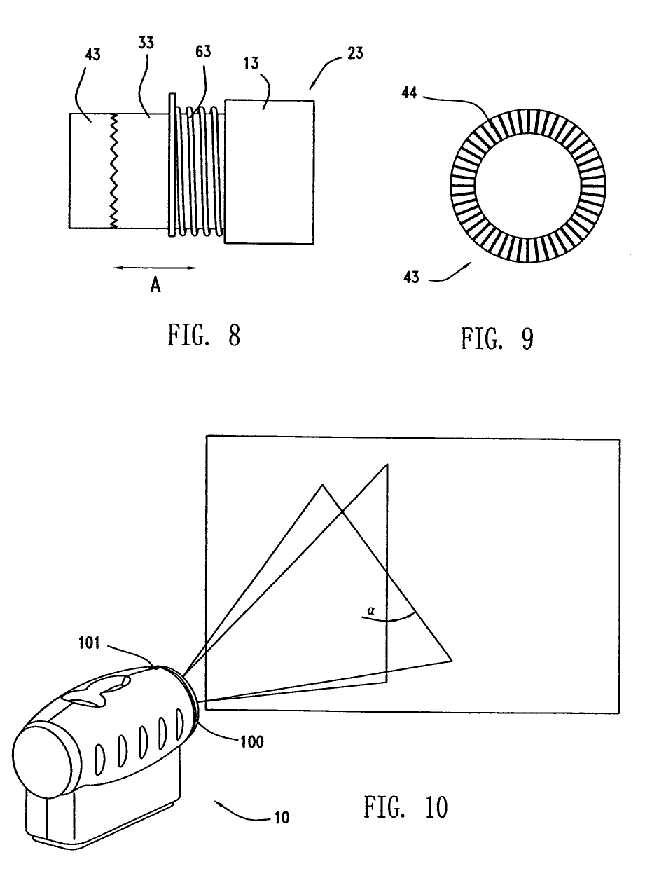

As shown in FIG. 8 and FIG. 9, a laser rotating-locating system 23 according to a fourth embodiment of the present invention comprises a fixing member 33, a rotating member 43 and a spring 63. There are one circle round of radiate teeth 44 at the opposite faces of the rotating member 43 and the fixing member 33, respectively, so that the teeth can be engaged each other. The other end of the fixing member 33 is actuated by a guiding member 13 and cannot be rotated but can only move along a direction shown by the arrowhead “A” in FIG. 8. The spring is positioned between the fixing member 33 and the guiding member 13. When the rotating member 43 is rotated relative to the fixing member 33 in an effect of an external force, each pair of teeth engaged with each other can be actuated to slide along the side walls of the opposite slots between the teeth, respectively so that tips of the teeth are actuated to break off from roots of the opposite teeth and the fixing member 33 is actuated to press the spring. The compression quantity of the spring is maximized when tips of the teeth contact with each other. When the rotating member is continuously rotated, the teeth are actuated to slide into the opposite slots again in an effect of the pressing force of the spring so that the engagement can be obtained again. As a result, a location can be realized when the rotating member 43 is actuated to slide across a space of a tooth, so that the 360-degrees rotation can also be realized.

As shown in FIG. 1, the rotating member 4 preferably includes a knob 40, or any other externally accessible member, thereby the rotating member 4 can be rotated by the operator via rotating the knob 40 so that the rotation of the laser can be achieved. The graduation 100 and the denoting arrowhead 101 are provided on the circumference of the rotating knob 40 adjacent to the housing 1. As shown in FIG. 10, when the knob 40 is rotated across a degree to make a reading from the graduation 100 pointed out by the denoting arrowhead 101 increase or decrease a value of degree α, the laser line formed on a wall by the laser is accordingly rotated by a value of degree α. The positions of the graduation 100 and the denoting arrowhead 101 are not uniquely settled and can also be provided on the other positions on the rotating member and on the fixing member.

The line-marking device 10 with rotatable laser according to the present invention can be used as a line-marking device independently or can be used in combination with all kinds of the electric tools and the home-improvement tools.

The laser line-marking device according to the present invention is not limited to the above-mentioned embodiments and can be realized in other forms that fulfill the same object. While the specific embodiments have been illustrated and described, numerous modifications come to mind without significantly departing from the spirit of the invention, and the scope of protection is only limited by the scope of the accompanying claims.

What I claim is:

1. A line-marking device with rotatable laser, comprising:
a laser rotating and locating system comprising a fixing member and a rotating member; wherein
one of said fixing member and said rotating member having a gear-shaped component, and
the other of said fixing member and said rotating member having a component that can be engaged with said gear-shaped component, and
said laser rotating and locating system also including an elastic member.

2. The line-marking device with rotatable laser as claimed in claim 1, wherein
said elastic member is a spring plate having one end fixed on said fixing member or said rotating member, and
said component engagable with said gear-shaped component is a protrusion which is fixed on the other end of said spring plate.

3. The line-marking device with rotatable laser as claimed in claim 1, wherein
said elastic member is a spring having one end which is fixed, and
said component engagable with said tooth-shaped component is spherical-shaped.

4. The line-marking device with rotatable laser as claimed in claim 1, wherein
at least a portion of one of said fixing member and said rotating member is located inside a cavity of the other one of said two members, the cross section of said cavity having a circular shape, and
said gear-shaped component is located on the surface of said fixing member adjacent to said rotating member.

5. The line-marking device with rotatable laser as claimed in claim 1, wherein
said component engagable with said gear-shaped component is a group of teeth.

6. The line-marking device with the rotatable laser as claimed in claim 1 further comprising:
a graduation and a denoting symbol, and
a component having said graduation can be rotated with respect to a component having said denoting symbol.

7. A laser generating device comprising:
a housing;
a laser-emitting assembly including a laser generator and a lens; and
means for rotating one of either the laser generator or the lens.

8. The laser generating device of claim 7, wherein the means for rotating comprises a rotating member and a fixing member.

9. The laser generating device of claim 8, wherein the rotating member comprises a plurality of slots that co-operate with the fixing member to hold the laser generator in a given position.

10. The laser generating device of claim 8, wherein the fixing member comprises a spring plate having a protrusion that co-operates with the rotating member to hold the laser generator in a given position.

11. The laser generating device of claim 8, wherein the fixing member comprises a spring and a cylindrical-shaped member that co-operates with the rotating member to hold the laser generator in a given position.

12. The laser generating device of claim 11, wherein the cylindrical-shaped member is a ball.

13. A laser generating device comprising:
a housing having a base defining a base plane;
a laser generator positioned within the housing for projecting a laser beam through a lens to form a laser line on a surface to be illuminated;
a manually operated rotating mechanism connected to one of either the laser generator or the lens, wherein upon rotation of the rotating mechanism the laser line may be selectively adjusted from an angle between 0 and 90 degrees with the base plane.

14. The laser generating device of claim 13, wherein the manually operated rotating mechanism comprises a rotating member and a fixing member.

15. The laser generating device of claim 13, further comprising a graduation and denoting member for indicating a value of the angle upon adjustment.

16. The laser generating device of claim 14, wherein the rotating member comprises a plurality of slots and the fixing member comprises a biasing member having a first fixed end and a protrusion on the second end that cooperates with the slots of the rotating member for holding either the laser generator or lens in a given position.

17. A laser line generating device comprising:
a housing;
a laser generator;
a lens, the laser generator adapted to pass a laser beam through the lens and project a laser line on a surface to be illuminated;
a manually operated rotating mechanism connected to one of either the laser generator or the lens to selectively rotate the line on the surface from a starting reference line of 0 degrees to a desired angle up to 360 degrees from the starting reference line.

18. The laser line generating device of claim 17 further including means for holding the one of either the laser generator or the lens such that the laser line is located at the desired angle up to 360 degrees from the starting reference line.
